(19) United States
(12) Patent Application Publication
(10) Pub. No.: US 2022/0364901 A1
(43) Pub. Date: Nov. 17, 2022

(54) CONTROLLING ASSESSMENT OF STORAGE HEIGHT

(71) Applicant: Hewlett-Packard Development Company, L.P., Spring, TX (US)

(72) Inventors: TONG NAM SAMUEL LOW, Singapore (SG); PUI WEN HUANG, Singapore (SG); YU ZHAO, Singapore (SG); WEI CHUN LIM, Singapore (SG)

(21) Appl. No.: 17/771,580

(22) PCT Filed: Dec. 20, 2019
(86) PCT No.: PCT/US19/67877

§ 371 Date: Apr. 25, 2022

(51) Int. Cl. G01F 23/292

(52) U.S. Cl. CPC G01F 23/2921

(57) ABSTRACT

Techniques for controlling assessment of storage height are described. In an example, a device includes an optical transducer and a light source. The optical transducer generates a signal corresponding to light received from the light source. Based on the signal, brightness of the light source may be controlled.

### BACKGROUND

Materials may be stored up to a storage height in containers. For instance, a printing device may include a media tray in which sheets of printable media, such as paper, may be stacked. Similarly, a shredding device may include a bin in which shredded pieces of printable media may be stored. The storage height, to which the materials are stored in the container, may be assessed based on optical signals. For instance, a light source and a light sensor may be coupled to opposite walls of the container. Receipt of optical signals from the light source by the light sensor may indicate that the materials are stored to a height below a threshold height.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a device in which height to which a material is stored is assessed, according to an example implementation of the present subject matter;

FIG. 2 illustrates a device in which storage height is assessed based on optical signals, according to an example implementation of the present subject matter;

FIG. 3 illustrates a printing device in which storage height is assessed based on optical signals, according to an example implementation of the present subject matter;

FIG. 4 illustrates a printed circuit assembly (PCA) of a printing device, according to an example implementation of the present subject matter;

FIG. 5 illustrates an electrical signal received due to light with low intensity being incident on a phototransistor, according to an example implementation of the present subject matter;

FIG. 6 illustrates a control circuit for controlling brightness of a light source based on detection of particulate matter deposition, according to an example implementation of the present subject matter;

FIG. 7 illustrates a control circuit for increasing brightness of a light source based on detection of particulate matter deposition, according to an example implementation of the present subject matter;

FIG. 8 illustrates a control circuit for facilitating increase of sensitivity of an optical transducer, according to an example implementation of the present subject matter;

FIG. 9 illustrates a control circuit for facilitating increase of sensitivity of an optical transducer, according to an example implementation of the present subject matter; and

FIG. 10 illustrates a computing environment, implementing a non-transitory computer-readable medium for controlling assessment of storage height of printable media in a device, according to an example implementation of the present subject matter.

### DETAILED DESCRIPTION

A device that stores materials may assess a height to which the materials are stored in it for various purposes. For instance, a printing device storing printable media may determine whether sheets of printable media are stacked above a threshold height to prevent jamming of the sheets during printing. A shredding device may determine whether shredded pieces of printable media are stored above a threshold height in a bin to provide a prompt for disposal of the pieces from the bin.

The aforesaid determination may involve the usage of optical signals. For instance, light emitted from a light source may be received by a light sensor that may in turn generate a signal corresponding to an intensity of the light received. When the materials are stored above the threshold height, the materials may block the light emitted from the light source. Hence, the intensity of light received by the light sensor reduces or drops to zero, causing generation of a signal with a relatively less magnitude or causing no generation of signal. The signal with less magnitude or absence of signal may indicate storage of printable media above the threshold height.

Sometimes, particulate matter, such as dust and grime, for example, in the environment or operation of a device, may be deposited on the light source, the light sensor, or both, over the life of the device or during servicing of the device. The deposition of particulate matter may cause reduction in the intensity of light received by the light sensor due to reduced transmittivity of the light source or the light sensor. Accordingly, a signal of less magnitude (as compared to a signal received without particulate matter deposition or less particulate matter deposition within a device) or no signal may be generated by the light sensor, causing a false detection that the printable media are stored above the threshold height.

The present subject matter relates to controlling assessment of storage height of materials in devices. With the implementations of the present subject matter, particulate matter deposition may be accurately detected and compensated for and hence storage height of materials may be accurately assessed.

In accordance with an example implementation of the present subject matter, a device may include a light source and an optical transducer that facilitate the determination of whether a material is stored above a threshold height. In an example, the material may be printable media and the device may be a device that stores printable media, such as a printing device, a shredding device, a fax machine, or a photocopier. The light source may emit light and the optical transducer may receive the light and generate a signal, such as an electrical signal, corresponding to an intensity of light received. The intensity of light may be less than a threshold intensity when the storage height is above the threshold height. This may be because, for a storage height above the threshold height, a portion of the light emitted by the light source may be blocked by the material. In an example, the optical transducer may include a phototransistor or a photodiode that can generate photocurrent depending on the intensity of light received.

The signal generated by the optical transducer may be received by a controller, such as an Application Specific Integrated Circuit (ASIC) or a processor, of the device. Based on the signal, the controller may determine whether the intensity of light received is less than that expected when the storage height is below the threshold height. In some cases, the light with less intensity than an expected intensity may be received when storage height is below the threshold height due to an error. The error may be, for example, due to particulate matter deposition on the light source, optical transducer, or both, or due to ageing of the light source, the optical transducer, or both. The light with less intensity than the expected intensity may be referred to as light with low intensity. The light with low intensity may be less than that expected, but it may be higher than what is expected when the storage height crosses the threshold height.

The controller may determine that the light with low intensity is received for a storage height below the threshold height. For the determination, the controller may leverage digital signals generated by it. The digital signals may be generated based on magnitudes (interchangeably referred to as “values”) of samples of electrical signal. For instance, the controller may generate a first digital signal, such as a logic 1 or high signal, if the sample has a value in a first range of values and may generate a second digital signal, such as a logic 0 or low signal, if the sample has a value in a second range of values. The first range of values (hereinafter, “the first range”) may be received if a storage height is below the threshold height and the second range of values (hereinafter, “the second range”) may be received if the storage height is above the threshold height.

When light with low intensity is received by the optical transducer for storage height below the threshold height, the value of the electrical signal may be outside of the first range and the second range, such as between the first range and the second range. In such cases, for a sample of the electrical signal, the controller may generate either the first digital signal or the second digital signal. The generation of either the first digital signal or the second digital signal may be, for example, because the value of the electrical signal may vary with time due to the error. Accordingly, while the electrical signal may have a value closer to the first range at a first point of time, the electrical signal may have a value closer to the second range at a second point of time.

The controller may also identify a variability in the digital signals generated by it. For instance, the controller may determine if a set of digital signals includes both first digital signals and second signals. The set of signals may be successive signals, such as 100 successive digital signals, generated by the controller. The variability in the digital signals may indicate that the light with low intensity is received for a storage height below the threshold height. Upon identification of the variability, in an example, the controller may control, such as increase, brightness of the light source. In another example, upon identifying the variability, the controller may control sensitivity of the optical transducer. In a further example, the controller may control brightness of the light source and also the sensitivity of the optical transducer. The control of the brightness, the sensitivity, or both, compensates for the error. For instance, the increase in the brightness increases the intensity of light received by the optical transducer, which in turn causes the value of electrical signal to fall within the first range of values.

In addition to identifying the variability, in an example, the controller may hold off generation of alarms based on second digital signals until it is confirmed that the second digital signals were not generated due to the variability. For instance, even if a second digital signal is received, the controller may hold off generation of the alarm until a plurality of digital signals is analyzed. If the plurality of digital signals has a variability, the controller may infer that the second digital signal was generated due to an error and not due to the storage height being above the threshold height, and may not generate the alarm. Therefore, the false generation of alarms is prevented.

The present subject matter thus facilitates reliable detection as to when storage height of a material in a device exceeds a threshold height. For instance, the present subject matter prevents generation of false alarms due to particulate matter deposition on components utilized for height assessment. Also, the present subject matter utilizes control components, such as ASIC, that are already utilized devices storing printable media. Further, the present subject matter may not utilize additional components, such as analog-to-digital converter (ADC), for processing of the signal generated by the optical transducer. Accordingly, the present subject matter can be implemented in a simple and a cost-effective manner.

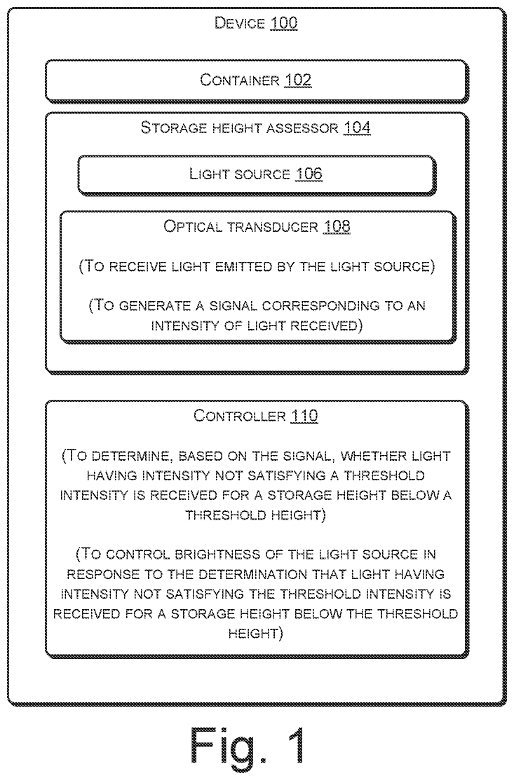

The present subject matter is further described with reference to FIGS. 1-8. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

In the description provided below, the present subject matter is explained with reference to devices storing printable media. However, the present subject matter can be utilized in devices where other types of material are stored, such as liquids, and in which optical signals are used for assessing storage height. Further, in the description provided below, the present subject matter is explained with reference to compensation for particulate matter deposition on optical components, such as a light source and a light sensor. However, the present subject matter can be utilized for compensating for ageing effects of the optical components. For instance, a decrease in intensity of light emitted by the light source due to ageing can be compensated for by increasing its brightness or increasing sensitivity of optical transducer.

FIG. 1 illustrates a device 100 in which height to which a material is stored is assessed, according to an example implementation of the present subject matter. The material may be printable media and the device 100 may be printable media-based device, such as a printing device, which can print on a sheet of printable medium, or a shredding device, which can shred a sheet of printable medium. The printable medium may be, for example, a paper, card stock, fabric, photo paper (on which photographs are printed), or the like. To store the material, such as sheets of printable media (in case of a printing device) or pieces of printable media (in case of a shredding device), the device 100 may include a container 102. In case of a printing device, the container 102 may be a media tray, through which printable media are received for printing, or an output bin, in which printable media are stored after printing. In case of a shredding device, the container 102 may be a bin, in which shredded pieces of printable media are stored. A height up to which the material is stored in the container 102 may be referred to as a storage height. In the case of a printing device, where the printable media are stacked, the storage height may also be referred to as a stacking height. Hereinafter, the material will be explained with reference to printable media.

The device 100 may include a storage height assessor 104 to facilitate assessment of the storage height. The assessment of storage height may include determining whether the storage height is above a threshold height. The storage height assessor 104 may include a light source 106 to emit light and an optical transducer 108 to receive the light and generate a signal, such as an electrical signal, corresponding to an intensity of received light. In an example, the intensity of light received may decrease with increasing storage height, as, with increasing storage height, more amount of light from the light source 106 may be blocked by the printable media. Further, for a storage height above the threshold height, the intensity of light received may not satisfy a threshold intensity. For instance, the intensity of light received may be less than the threshold intensity.

The reduction in intensity of light received may cause a corresponding change in a value of the signal, which may be utilized to determine if the storage height is above the threshold height. In some cases, the intensity of light received may not satisfy the threshold intensity even for a storage height below the threshold height if particulate matter, such as dust, is deposited on the light source 106, the optical transducer 108, or both.

The light source 106 may be, for example, a light emitting diode (LED). The optical transducer 108 may include a light sensor (not shown in FIG. 1), which can sense the light emitted by the light source 106 and can output a corresponding signal. The light sensor may be, for example, phototransistor or a photodiode, which may generate a photocurrent corresponding to the intensity of light received. In an example, in addition to the light sensor, the optical transducer 108 may also include an output transistor (not shown in FIG. 1), which may receive a voltage corresponding to the photocurrent at its base terminal and generate a corresponding voltage signal at its collector terminal.

The device 100 may also include a controller 110, which may be, for example, an Application Specific Integrated Circuit (ASIC). The controller 110 may receive the signal output by the optical transducer 108. Based on the signal, the controller 110 may determine whether the light having intensity not satisfying the threshold intensity is received for a storage height below the threshold height. Such a determination may be performed based on a value of the signal. For instance, if the signal has a value between a range of values corresponding to storage height above the threshold height and a range of values corresponding to storage height below the threshold height, the controller 110 may determine that the low intensity is received for a storage height below the threshold height. In response to such a determination, the controller 110 may control, such as increase, brightness of the light source 106. The increase in brightness may cause an increase in the intensity of light received by the optical transducer 108.

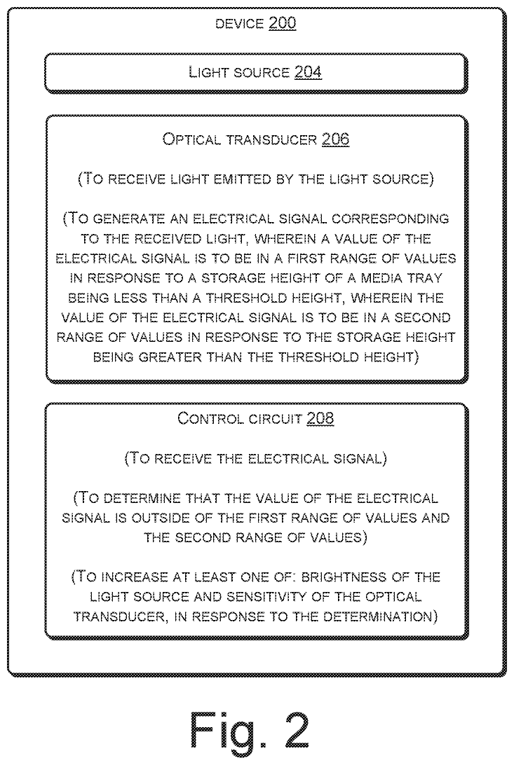

FIG. 2 illustrates a device 200 in which storage height is assessed based on optical signals, according to an example implementation of the present subject matter. The device 200 may be, for example, a printing device and may correspond to the device 100. In the below description, the device 200 will be explained with reference to a printing device and will be referred to as the printing device 200.

The printing device may include a light source 204 and an optical transducer 206, which may correspond to the light source 106 and the optical transducer 108 respectively. The optical transducer 206 may receive light emitted by the light source 204 and generate an electrical signal corresponding to the received light to facilitate assessment of a height to which the sheets are stacked in a media tray. The media tray may correspond to the container 102. The height to which sheets are stacked in the media tray may be referred to as a storage height or stacking height of the media tray.

A value of the electrical signal may be in a first range of values (hereinafter, “the first range”) if the stacking height is less than the threshold height and in a second range of values (hereinafter, “the second range”) if the stacking height is above the threshold height. The first range may be, for example, 0.7*Vcc-Vcc, and the second range may be, for example, 0-0.3*Vcc, where Vcc is a supply voltage.

In some cases, particulate matter, such as dust and grime, may be deposited on the light source 204, the optical transducer 206, or both. The deposition of particulate matter may cause decrease in intensity of the light received by the optical transducer 206, even if there is no increase in the stacking height. The decrease in the intensity of light may cause the electrical signal to have a value outside of the first range, even if the stacking height is below the threshold height. For instance, the sample of electrical signal may have a value between the first range and the second range. In an example, the intensity of light less than which the electrical signal has a value outside of the first range may be the threshold intensity. Further, in an example, the threshold intensity may be the intensity of light received when the storage height equals the threshold height.

The printing device 200 may further include a control circuit 208 that can control assessment of the stacking height based on a determination that particulate matter is deposited on the light source 204, optical transducer 206, or both. The control circuit 208 may correspond to the controller 110. In an example, the control circuit 208 may be a part of a printed circuit assembly (PCA) of the printing device 200. Further, in an example, the control circuit 208 may be an Application Specific Integrated Circuit (ASIC).

The control circuit 208 may receive the electrical signal and determine if the value of the electrical signal is outside of the first range and the second range, such as between the first range and the second range. The value of the electrical signal may be outside of the first range and the second range if particulate matter is deposited on the light source 204, the optical transducer 206, or both. Accordingly, the determination that the value of the electrical signal is outside of the first range and the second range may indicate that particulate matter is deposited on at least one of: the light source 204 and the optical transducer 206.

In an example, to determine that the value of the electrical signal is outside of the first range and the second range, the control circuit 208 may utilize digital signals, such as logic 0 signals and logic 1 signals, corresponding to values of samples of the electrical signal, as will be explained subsequently. In accordance with the example, an analog-to-digital converter (ADC) may not be utilized to digitize the electrical signal for measurement of the value of the electrical signal.

In another example, the determination may be performed based on a measurement of the value of the electrical signal. For instance, the control circuit 208 may measure the value of the electrical signal and determine that particulate matter is deposited (i.e., determine that light having intensity not satisfying the threshold intensity) if the measured value is between the first range and the second range. To determine that the value is outside of the first range and the second range based on the measurement, in an example, the control circuit 208 may include an ADC (not shown in FIG. 2) to digitize the samples of electrical signal for subsequent measurement.

In response to the determination that particulate matter is deposited on the light source 204, in an example, the control circuit 208 may increase brightness of the light source 204. In another example, in response to the determination, the control circuit 208 may increase sensitivity of the optical transducer 206. In a further example, in response to the determination, the control circuit 208 may increase both the brightness of the light source 204 and the sensitivity of the optical transducer 206.

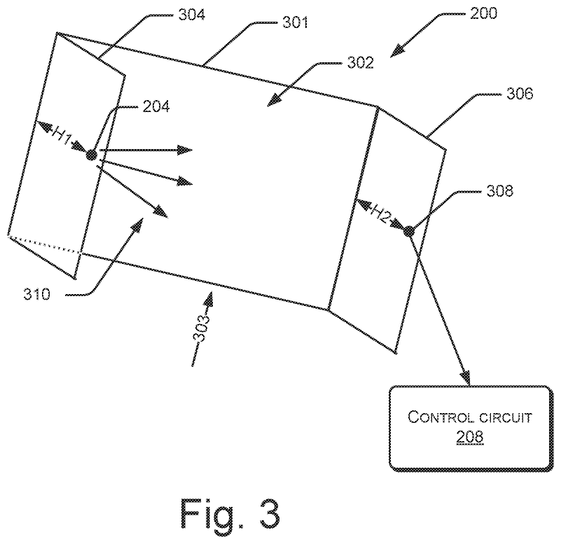

FIG. 3 illustrates the printing device 200 in which storage height is determined based on optical signals, according to an example implementation of the present subject matter.

The printing device 200 includes a media tray 301 having a planar surface 302 on which sheets of printable medium (not shown in FIG. 3) may be received and stacked. The sheets may be received on the planar surface 302 in a direction indicated by an arrow 303. From the planar surface 302, the sheets may be fed to a body (not shown in FIG. 3) of the printing device 200 for printing. The media tray 301 may include a first leg 304 and a second leg 306. The first leg 304 and the second leg 306 may be disposed perpendicular to the planar surface 302 and may face each other. When printable media are placed on the planar surface 302, the printable media may be present between the first leg 304 and the second leg 306. In an example, the first leg 304 and the second leg 306 can be moved relative to each other along the planar surface 302. For instance, from their respective positions depicted in FIG. 3, the legs 304 and 306 can be moved towards each other. The movement of the legs 304 and 306 relative to each other may be performed based on width of the printable medium placed on the planar surface 302. For instance, upon placing the printable media on the planar surface 302, the legs 304 and 306 may be moved towards each other until they are adjacent to opposite sides of the printable media.

In some cases, the height to which the printable media are stacked (i.e., the stacking height) on the planar surface 302 may have to be monitored. This is because an excessive stacking height may cause jamming of printable media when they are supplied for printing. Also, the excessive stacking height may cause spillage of some sheets of printable media, which may be pushed by other sheets during operation of the printing device 200. To monitor the stacking height, the printing device 200 may include the light source 204 and a light sensor 308. The light sensor 308 may be part of the optical transducer 206.

The light source 204 and the light sensor 308 may be disposed on the legs 304 and 306. For instance, the light source 204 may be disposed on the first leg 304 and the light sensor 308 may be disposed on the second leg 306. Thus, light 310 emitted by the light source 204 may reach the light sensor 308. When sheets of printable media are stacked on the planar surface 302, the sheets are between the light source 204 and the light sensor 308. Therefore, a portion of the light 310 emitted by the light source 204 may be blocked by the sheets and may not reach the light sensor 308. Further, with an increase in the stacking height, more amount of light from the light source 204 may be blocked by the sheets, causing a decrease in the intensity of light received by the light sensor 308.

In an example, a height (H1) at which the light source 204 is disposed on the first leg 304 may be equal to a height (H2) at which the light sensor 308 is disposed on the second leg 306. Further, the height (H1, H2) may be the height beyond which printable media are not to be stacked on the planar surface 302, and may be referred to as the threshold height. The stacking of sheets above the threshold height may cause blockage of the light 310 by the sheets. Thus, little or no light may be received by the light sensor 308. In an example, in addition to the light sensor 308, other light sensors (not shown in FIG. 3) may be disposed below the light sensor 308. Such other sensors may also facilitate determination of the stacking height in a similar manner.

The light sensor 308 may generate a signal corresponding to the intensity of light received from the light source 204. For instance, the light sensor 308 may be a phototransistor, which may output a photocurrent based on the intensity of the light sensed. In an example, a voltage output by the light sensor 308, which corresponds to the photocurrent, may be received by the control circuit 208 of the printing device 200. In another example, the voltage output by the light sensor 308 may be received by an output transistor (not shown in FIG. 3), which may output a corresponding voltage.

In an example, the light source 204 and the light sensor 308 may be part of a retro-reflective sensor. In accordance with the example, both the light source 204 and the light sensor 308 may be coupled to the same wall of the media tray 301. When the printable media are stacked below the threshold height, light from the light source 204 may be reflected off the opposite wall and may be received at the light sensor 308. Accordingly, a high intensity of light may be received by the light sensor. When the printable media are stacked above the threshold height, light from the light source 204 may not reach the opposite wall, but may be blocked by the printable media. Further, a portion of the blocked light may be reflected by the printable media. In such a case, the intensity of reflected light may be less than that received from the opposite wall when the storage height was below the threshold height. Accordingly, the photocurrent and the voltage from the output transistor may vary due to increase in the stacking height.

Based on the voltage from the light sensor 308 or the output transistor, the control circuit 208 may determine whether the stacking height is above the threshold height and may generate an alarm if the stacking height is above the threshold height. The alarm may be provided in the form of an audio output or a visual output. To provide the alarm, the control circuit 208 may utilize a loudspeaker or a display (not shown in FIG. 3) of the device 200. The control circuit 208 may also prevent false generation of alarms due to particulate matter deposition on the light source 204, light sensor 308, or both, as will be explained below.

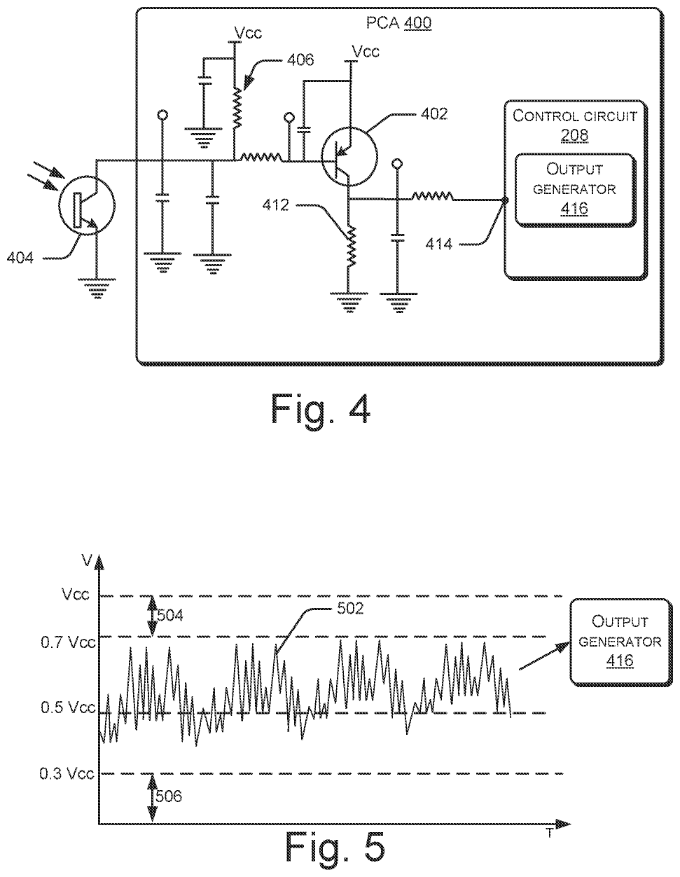

FIG. 4 illustrates a PCA 400 of the printing device 200, according to an example implementation of the present subject matter. The PCA 400 may include an output transistor 402 that supplies an electrical signal to the control circuit 208. The electrical signal may correspond to the signal explained with reference to FIG. 1 and the electrical signal explained with reference to FIG. 2. The output transistor 402 may receive voltage from a phototransistor 404 at its base terminal. The base terminal may also be connected to the voltage supply (Vcc) through a resistor 406. The phototransistor 404 may correspond to the light sensor 308.

In an example, the phototransistor 404 and the output transistor 402 may be part of the optical transducer 206. Also, in an example, the phototransistor 404 and the light source 204 may be part of a transmissive-based sensor or a retro-reflective sensor.

In an example, the output transistor 402 may be a PNP transistor and may supply the electrical signal from its collector terminal to the control circuit 208. Further, the phototransistor 404 may be an NPN transistor and may be connected to the base terminal of the output transistor 402 from its collector terminal. An emitter terminal of the phototransistor 404 may be connected to ground. Further, the phototransistor 404 may receive the light emitted by the light source 204 at its base terminal.

When the phototransistor 404 receives a high intensity of light, such as due to stacking of printable media below the stacking height, the phototransistor 404 may act as a closed switch, causing a minimal voltage drop across its collector terminal and ground. For instance, a large value of current flows from Vcc through the output transistor 402 and the phototransistor 404 to ground. Accordingly, a minimal voltage appears at the base terminal of the output transistor 402. Since the output transistor 402 is a PNP transistor, the minimal voltage drop may drive the output transistor 402 into a saturation region, causing the output transistor 402 to act as a closed switch. Therefore, almost all of the supply voltage (Vcc) supplied to the emitter terminal of the output transistor 402 may appear at its collector terminal. This causes a high voltage drop across a resistor 412, which is connected to the collector terminal. The collector terminal of the output transistor 402 and the resistor 412 may be connected to an input terminal 414, such as a general purpose Input/Output (GPIO) terminal, of the control circuit 208. Accordingly, a high voltage is received at the input terminal 414.

When a low intensity of light or no light is received at the base terminal of the phototransistor 404, such as due to the stacking height being above the threshold height, the voltage drop across its collector terminal and ground may be much higher. For instance, a less amount of base current flows from Vcc through the output transistor 402 and the phototransistor 404 to ground. Therefore, the voltage at the base terminal of the output transistor 402 increases. The increase in the base voltage of the output transistor 402 may cause the output transistor 402 to operate in a cut-off region. In the cut-off region, the output transistor 402 may act as an open switch, causing minimal voltage to appear across the resistor 412, and minimal voltage to appear at the input terminal 414.

The control circuit 208 may include an output generator 416 to generate digital signals based on a value of the electrical signal, which is received at the input terminal 414. The output generator 416 may be implemented as hardware, instructions executed by a processor, or by a combination thereof. The processor may be part of the control circuit 208 and may be implemented as a microprocessor, a microcomputer, a microcontroller, a digital signal processor, a central processing unit, a state machine, a logic circuitry, or a device that manipulates signals based on operational instructions. Among other capabilities, the processor may fetch and execute computer-readable instructions stored in a memory (not shown in FIG. 4), such as a volatile memory or a non-volatile memory, of the control circuit 208.

The output generator 416 may receive samples of the electrical signal and generate a digital signal corresponding to each sample. A digital signal generated by the output generator 416 may either be a first digital signal or a second digital signal. The first digital signal may also be referred to as a first logic signal and may be, for example, a logic 1 signal, which may correspond to a voltage value, such 3.3 V. The second digital signal may also be referred to a second logic signal and may be, for example, a logic 0 signal, which may have a voltage value of 0 V.

The digital signal generated may depend on the value of a sample of the electrical signal. For instance, for a sample with a high voltage value, such as≈Vcc, the output generator 416 may generate the first digital signal. Similarly, for a sample with a low voltage value, such as≈0, the output generator 416 may generate the second digital signal. In an example, to account for errors and ageing effects of various components, the output generator 416 may generate a digital signal for a voltage value within a range of voltage values. For instance, the output generator 416 may generate the first digital signal for a sample of the electrical signal having a value between 0.7*Vcc and Vcc. Similarly, the output generator 416 may generate the second digital signal for a sample of the electrical signal having a value between 0 and 0.3*Vcc. A range of values for which the output generator 416 generates the first digital signal may be referred to as a first range of values and a range of values for which the output generator 416 generates the second digital signal may be referred to as a second range of values. The first range of values and the second range of values may be the first range and the second range, respectively, explained with reference to FIG. 2. The first range of values and the second range of values may not overlap with each other. For instance, no voltage value may fall within both the first range and the second range.

In some cases, due to particulate matter deposition on the light source 204, the phototransistor 404, or both, the intensity of light received by the phototransistor 404 may be reduced, even if the stacking height is below the threshold height. Further, the intensity of light received below the threshold height due to particulate matter deposition may still be greater than that received when the stacking height is above the threshold height. Accordingly, the low intensity of the light may cause electrical signal to have a value outside of the first range and the second range, such as between the first range and the second range, as will be explained below.

FIG. 5 illustrates the electrical signal 502 received due to light with low intensity being incident on the phototransistor 404, according to an example implementation of the present subject matter. Here, the first range 504 may be 0.7*Vcc-Vcc and the second range 506 may be 0-0.3*Vcc. Due to reduction in the intensity of light incident on the phototransistor 404, the voltage received at the base terminal of the output transistor 402 may increase. In such a case, the output transistor 402 may not operate in the saturation region, but may operate in its active region. Accordingly, the electrical signal 502 may have a value between the first range 504 and the second range 506.

In addition to having a value between the first range 504 and the second range 506, the electrical signal 502 may vary in value over time. The variation in value may be because of the particulate matter deposition. Further, since the electrical signal 502 is received as a result of amplification by two transistors (phototransistor 404 and output transistor 402), minor variations in the intensity of light may cause significant variations in the value of the electrical signal 502. The variations in the value of the electrical signal 502 may cause variations in the digital signal generated by the output generator 416. For instance, for a sample of the electrical signal 502 having a value above 0.5*Vcc, the output generator 416 may generate the first digital signal as output and for a sample of the electrical signal 502 having a value below 0.5*Vcc, the output generator 416 may generate the second digital signal as output.

Accordingly, for a value of the electrical signal 502 between the first range 504 and the second range 506, either the first digital signal or the second digital signal is received. It may be noted that the particulate matter deposition may not always cause the electrical signal 502 to have a value between the first range 504 and the second range 506. For instance, if the particulate matter deposition is little, the intensity of light may not reduce considerably. Accordingly, the value of the electrical signal 502 may not drop to less than 0.7*Vcc, but may still be more than 0.7*Vcc. However, in the present subject matter, particulate matter deposition that causes the light intensity to reduce to such an extent, that the value of the electrical signal 502 drops below the first range 504 may be considered. As mentioned earlier, the intensity of light that causes the value of the electrical signal to drop below the first range 504 may be referred to as the threshold intensity. It may be understood that the threshold intensity may not be quantified, and the intensity of light received may not be measured. Rather, the intensity of light and the drop in intensity below the threshold intensity may be inferred based on the value of the electrical signal 502. Further, it will be understood that the first range 504 may be adjusted to a smaller range, such as 0.9*Vcc-Vcc, if smaller levels of particulate matter deposition is to be compensated for. Alternatively, the first range may be adjusted to a larger range as well.

In an example, the generation of the first digital signals and the second digital signals for values between the first range 504 and the second range 506 may be leveraged to detect the particulate matter deposition on the light source 204, the phototransistor 404, or both. In the below description, the particulate matter deposition on the light source 204 is explained. However, it will be understood that the explanation is applicable for particulate matter deposition on the light sensor 308 as well.

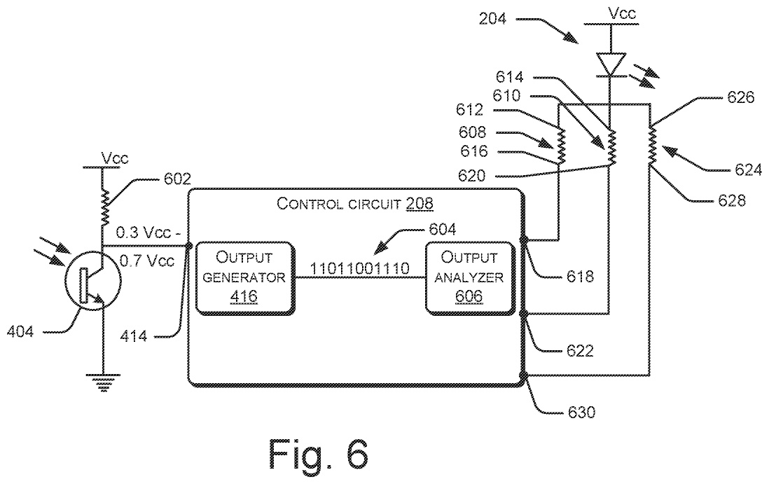

FIG. 6 illustrates the control circuit 208 for controlling brightness of the light source 204 based on detection of particulate matter deposition, according to an example implementation of the present subject matter.

As illustrated, the light source 204 may be an LED. Further, as illustrated, the phototransistor 404 may be directly connected to the input terminal 414 of the control circuit 208, instead of indirectly through the output transistor 402. The phototransistor 404 may be directly connected to the input terminal 414 if the output from the phototransistor 404 is of a relatively higher magnitude, and is not to be amplified before being supplied at the input terminal 414. Such a phototransistor may be referred to as an opto-interrupter or a single-channel encoder.

The collector terminal of the phototransistor 404 may be connected to the input terminal 414 and to the supply voltage (Vcc) through a resistor 602. Further, the emitter terminal of the phototransistor 404 may be connected to ground. In accordance with the example, the electrical signal, which is received by the control circuit 208 at the input terminal 414, may be the voltage across the phototransistor 404. Further, in accordance with the example, the optical transducer 206 may include the phototransistor 404, but not the output transistor 402.

When a high intensity of light is received from the light source 204, the voltage drop across the phototransistor 404 may be minimal, causing an electrical signal of low value to appear at the input terminal 414. Further, when a low intensity of light or no light is received from the light source 204, the voltage drop across the phototransistor 404 may be large, causing an electrical signal of a large value to appear at the input terminal 414. Therefore, for a stacking height less than the threshold height, a small electrical signal is received at the input terminal 414 and for a stacking height more than the threshold height, a large electrical signal is received. Therefore, in accordance with the present example, the first range may be 0-0.3*Vcc and the second range may be 0.7*Vcc-Vcc. Further, the first digital signal, which is generated in response to a sample in the first range, may be logic 0 signal and the second digital signal may be logic 1 signal. Alternatively, the output generator 416 may be configured such that it outputs a logic 1 signal as the first digital signal (i.e., for a sample in the first range) and a logic 0 signal as the second digital signal. In the below description, the first digital signal is explained as the logic 1 signal and the second digital signal is explained as the logic 0 signal.

As explained earlier, for a value of the electrical signal between the first range and the second range, the output generator 416 may output either the first digital signal or the second digital signal. The first digital signal may be represented as “1” and the second digital signal may be represented as “0”. Accordingly, for a plurality of successive samples of the electrical signal, a plurality of digital signals 604 including both “1” and “0” are generated.

The output generator 416 may supply the generated digital signals to an output analyzer 606, which may analyze digital signals. The output analyzer 606 may be implemented as hardware, instructions executed by a processor, or by a combination thereof. The output analyzer 606 may analyze a plurality of digital signals to detect particulate matter deposition. The analysis may be performed, for example, during starting-up of the printing device 200, periodically, when the media tray 301 is cleared, or in any combinations thereof. The plurality of digital signals may be for example, successive digital signals generated based on successive samples of the electrical signal.

The output analyzer 606 may also identify a variability in the plurality of digital signals. A variability in a set of digital signals refers to variation among values of digital signals of the set. For instance, if a set of digital signals has all its digital signals as logic 1 signal or all its digital signals as logic 0 signal, the set may be referred to as having no variability. Contrarily, if a set of digital signals has both logic 1 signals and logic 0 signals, the set may be referred to as having variability.

Since the output generator 416 generates both logic 0 signals and logic 1 signals for electrical signal with value between the first range and the second range, the plurality of digital signals may have both logic 0 signals and logic 1 signals. For instance, out of 100 digital signals received, 30 may be logic 0 signals and 70 may be logic 1 signals. Accordingly, the variability in the plurality of digital signals may indicate that light with low intensity is received for stacking height below the threshold height, such as due to particulate matter deposition. Thus, if the plurality of digital signals has a variability, the output analyzer 606 may infer that particulate matter is deposited on the light source 106.

To compensate for the particulate matter deposition, the output analyzer 606 may increase brightness of the light source 204. The increase in brightness may increase the intensity of light received by the phototransistor 404. Consequently, the value of electric signal may fall within the first range. Thus, the generation of logic 0 signals for a storage height below the threshold height is stopped.

To increase the brightness of the light source 204, the output analyzer 606 may cause an increase in the current supplied to the light source 204. To facilitate increasing current supplied to the light source 204, a terminal of the light source 204 may be connected to a plurality of resistors, each of which can connect the light source 204 to ground. Further, to increase the brightness, the output analyzer 606 may increase the number of resistors through which the light source 204 is connected to ground, as will be explained below:

The plurality of resistors may include as a first resistor 608 and a second resistor 610. A first terminal 612 of the first resistor 608 and a second terminal 614 of the second resistor 610 may be connected to one terminal of the light source 204. Further, the resistors 608 and 610 may also be connected to output terminals of the control circuit 208. For instance, a third terminal 616 of the first resistor 608 may be connected to a first output terminal 618 of the control circuit 208 and a fourth terminal 620 of the second resistor 610 may be connected to a second output terminal 622 of the control circuit 208. The first output terminal 618 and the second output terminal 622 may be GPIO terminals of the control circuit 208.

Originally, before increasing the brightness of the light source 204, the first output terminal 618 may be operated at a logic-0 mode and the second output terminal 622 of may be operated at a high-impedance mode. Accordingly, the first resistor 608 is connected to ground (through the first output terminal 618), while the second resistor 610 is not. Thus, before increasing the brightness, the light source 204 is connected to ground through the first resistor 608 alone. To increase the brightness, the control circuit 208 may change the mode of the second output terminal 622 from the high impedance mode to the logic-0 mode, causing the second resistor 610 to be connected to ground. Accordingly, the light source 204 is connected to ground through both the first resistor 608 and the second resistor 610. Therefore, an equivalent resistance value through which the light source 204 is connected to ground decreases from R1 to R1*R2/(R1+R2), where R1 is the resistance of the first resistor 608 and R2 is the resistance of the second resistor 610. The decrease in the resistance causes an increase in the current supplied to the light source 204.

In an example, upon increasing the brightness, the output analyzer 606 may determine if the reduction in intensity of light due to particulate matter deposition is compensated for by the increase in the brightness. To perform the determination, the output analyzer 606 may analyze subsequent digital signals, also referred to as a second plurality of digital signals, generated by the output generator 416. The second plurality of digital signals may be generated based on a second plurality of samples of electrical signal received after the brightness is increased. If the reduction in intensity is compensated for, the value of electrical signal may fall within the first range, and therefore, the second plurality of digital signals may have the first digital signals alone, and not the second digital signals. Therefore, if the second digital signals are absent in the second plurality of digital signals, the output analyzer 606 may deduce that the reduction in intensity due to particulate matter deposition has been compensated for.

After the particulate matter deposition has been compensated for, the output analyzer 606 may continue to monitor the digital signals generated by the output generator 416. If a second digital signal is received after the compensation, the output analyzer 606 may deduce that the second digital signal is received due to the stacking height exceeding the threshold height. Subsequently, the output analyzer 606 may trigger an alarm to indicate that the stacking height has exceeded the threshold height. By triggering an alarm for the stacking height after ensuring that the particulate matter deposition is compensated for, the present subject matter ensures that false alarms are not generated.

Upon increasing the brightness, if the second digital signals are still present in the second plurality of digital signals, the output analyzer 606 may deduce that the reduction in intensity due to particulate matter deposition is not yet compensated for. Based on such a deduction, the output analyzer 606 may further increase the brightness of the light source 204. To facilitate a further increase of brightness, the printing device 200 may include a third resistor 624. A fifth terminal 626 of the third resistor 624 may be connected to the terminal of the light source 204 and a sixth terminal 628 may be connected to a third output terminal 630 of the control circuit 208. The third output terminal 630 may be a GPIO terminal.

Before the further increase of brightness, the third output terminal 630 may be set at high-impedance mode. To increase the brightness, the third output terminal 630 may be changed to logic-0 mode, so that the third resistor 624 is connected to ground. This causes a further decrease in the equivalent resistance value through which the light source 204 is connected to ground and an increase in the current supplied to the light source 204.

In an example, after the particulate matter deposition is compensated for, such as using the second resistor 610 alone or using both the second resistor 610 and the third resistor 624, particulate matter may continue to get accumulated on the light source 204. The continued accumulation causes reduction in the intensity of light received by the phototransistor 404. Accordingly, after a period of time, the intensity of light may again drop to less than the threshold intensity. The drop in intensity causes variability in the digital signals from the output generator 416, as explained above, and may be detected by the output analyzer 606. Upon the detection, the output analyzer 606 may cause a further increase in the brightness, thereby compensating for the further accumulation of particulate matter.

As will be understood, the brightness may be increased using additional resistors (not shown in FIG. 6) upon deducing that the particulate matter deposition is not compensated for. The maximum current that the printing device 200 is capable of supplying to the light source 204 may be referred to as current supply capacity of the printing device 200. The current supply capacity of the printing device 200 depends on the number of resistors connected to the light source 204 and the resistance values of the resistors. In an example, the extent to which the brightness of the light source 204 can be increased may also depend on a current rating of the light source 204, which may be a maximum permissible value of current that is be supplied to the light source 204 without damaging the light source 204. The current rating may be specified by the manufacturer of the light source 204.

If, based on the current supply capacity or the current rating, it is determined that the current supplied to the light source 204 cannot be increased, the output analyzer 606 may disable the light source 204. Once the light source 204 is disabled, the output generator 416 continues to generate second digital signals, as no light is received by the phototransistor 404. The continuous stream of second digital signals is received even for a stacking height less than the threshold height. Therefore, to prevent generation of alarm in such a case, the output analyzer 606 may disable generation of alarm once the light source 204 is disabled.

In some cases, particulate matter may be heavily accumulated on the light source 204. Such a heavy accumulation may cause such a reduction in the light intensity that the electrical signal has a value in the second range. This causes generation of the second digitals signals regardless of the stacking height. Therefore, in such cases, the output analyzer 606 may disable the generation of alarm to prevent false alarms. The output analyzer 606 may also disable the light source 204, thereby saving power.

As will be understood, a continuous stream of second digital signals may be generated by the output generator 416 due to heavy accumulation of particulate matter and also due to the stacking height being above the threshold height. Therefore, to distinguish between the second digital signals received due to heavy particulate matter accumulation and the second digital signals received due to stacking height above the threshold height, in an example, the output analyzer 606 may utilize an input from a user of the printing device 200, as will be explained below:

Once a continuous stream of second digital signals is received, the output analyzer 606 may prompt the user to indicate whether the stacking height is above the threshold height. The prompt may be provided in the form of a visual prompt or an audio prompt. If the user indicates that the stacking height is not above the threshold height, the output analyzer 606 may deduce that the stream of second digital signals is received due to heavy accumulation of particulate matter and disable the light source 204. If the user indicates that the stacking height is above the threshold height, the user may be prompted to remove some sheets of the printable media to reduce the stacking height. Accordingly, such a prompt serves as the alarm.

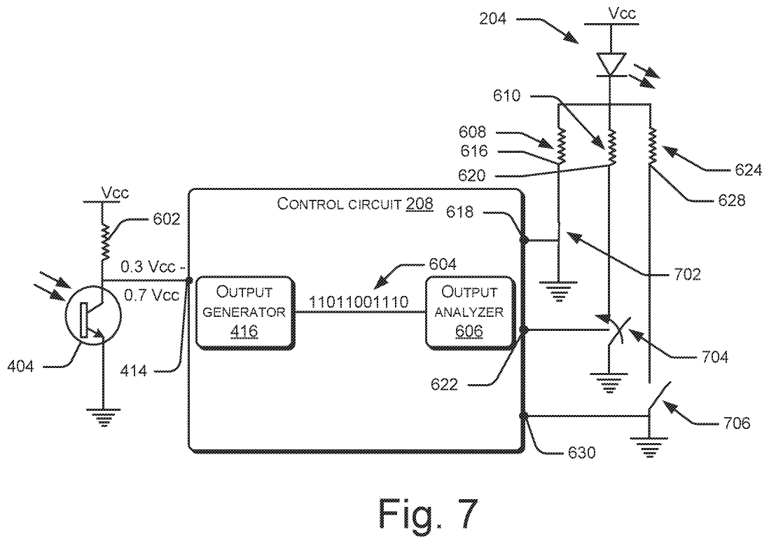

FIG. 7 illustrates the control circuit 208 for increasing brightness of the light source 204 based on detection of particulate matter deposition, according to an example implementation of the present subject matter. To increase the brightness, the control circuit 208 may increase the number of resistors through which the light source 204 is connected to ground, as explained earlier.

In an example, each resistor may be connected to an output terminal of the control circuit 208 through a switch. For instance, the third terminal 616 of the first resistor 608 may be connected to the first output terminal 618 through a first switch 702, the fourth terminal 620 of the second resistor 610 may be connected to the second output terminal 622 through a second switch 704, and the sixth terminal 628 of the third resistor 624 may be connected to the third output terminal 630 through a third switch 706. Further, the first switch 702, the second switch 704, and the third switch 706 may be connected to the third terminal 616, the fourth terminal 620, and the sixth terminal 628, respectively, to ground.

In an example, each switch may be a transistor, and an output terminal may be connected to a base terminal of the corresponding transistor. Accordingly, to connect the light source 204 to ground through a resistor, the control circuit 208 may supply a switching signal to the base terminal of the switch corresponding to that resistor. For instance, initially, before increasing the brightness, the control circuit 208 may provide the switching signal at the first output terminal 618 alone, causing the first resistor 608 to be connected to ground. To increase the brightness of the light source 204, the control circuit 208 may supply the switching signal at the second output terminal 622 as well.

The output terminals of the control circuit 208 may be connected to the resistors through switches in cases where the output terminals cannot withstand the current that may pass through the resistors. Hence, by connecting the output terminals to the resistors through switches, the control circuit 208 may be protected from damage due to excessive current.

Although increasing brightness has been explained above as being performed using resistors, in an example, the increase in brightness may be achieved using an LED driver (not shown FIG. 7) of the control circuit 208. The LED driver may be a programmable current source and may be connected to the cathode of the light source 204. Further, the LED driver may supply a current to the light source 204 for a range of values of supply voltage (Vcc).

Although compensation for the particulate matter deposition is explained as being performed by increasing brightness of the light source 204, in an example, the compensation may be performed by increasing sensitivity of the optical transducer 206. The sensitivity of the optical transducer 206 is a measure of the electrical signal generated by the optical transducer 206 for a given intensity of light from the light source 204. If the sensitivity of the optical transducer 206 is higher, for a given intensity, a higher value of the electrical signal is generated. Hence, if the intensity of light received from the light source 204 reduces, the electrical signal may be maintained at its earlier value by increasing the sensitivity of the optical transducer 206.

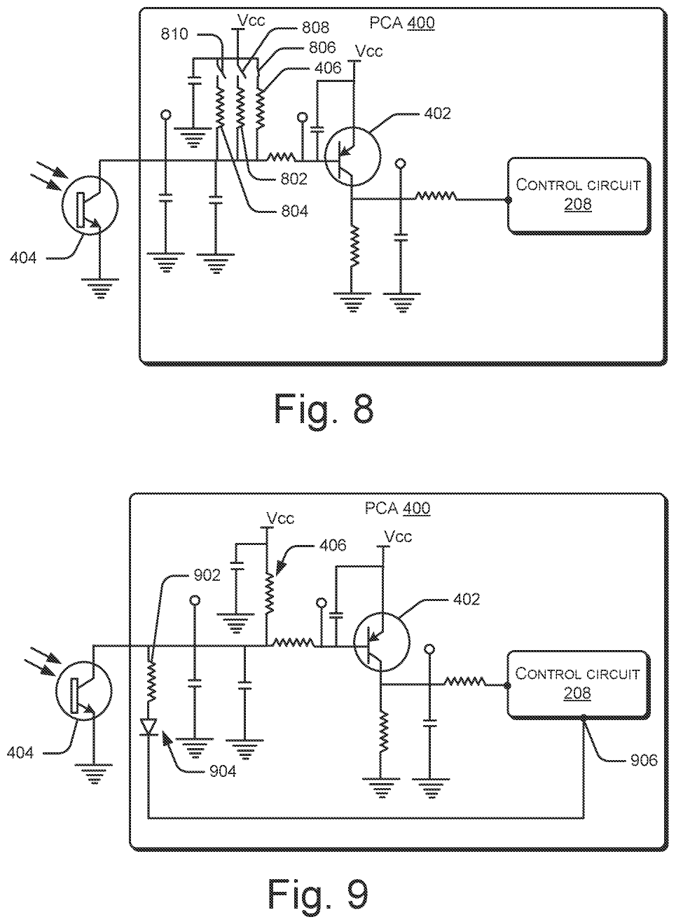

FIG. 8 illustrates the control circuit 208 for facilitating increase of sensitivity of the optical transducer 206, according to an example implementation of the present subject matter. The optical transducer 206 may include the output transistor 402, as explained earlier. To increase the sensitivity of the optical transducer 206, in an example, the voltage at the base terminal of the output transistor 402 may be controlled by the control circuit 208. If the output transistor 402 is a PNP transistor, to increase the sensitivity, the voltage at its base terminal may be decreased.

To decrease the voltage received at the base terminal, in an example, a plurality of resistors may be connected at the base terminal. The plurality of resistors may include the resistor 406 and resistors 802 and 804. The resistors 406, 802, and 804 may be connected to the voltage supply (Vcc) through respective switches 806, 808, and 810. To decrease the voltage received at the base terminal of the output transistor 402, a resistance of the path through which Vcc is connected to the base terminal may be increased. The resistance may be increased by the control circuit 208 by turning the switches 806, 808, and 810 on and off, as will be explained below:

In an example, originally, before increasing sensitivity, the resistance of the path through which Vcc is connected to the base terminal may be kept minimal by turning on the switches 806, 808, and 810. Subsequently, to increase sensitivity, one or two of the switches 806, 808, and 810 may be turned off, thereby increasing resistance of the path.

In another example, the resistors 406, 802, and 804 may have different resistance values. For instance, the resistor 406 may have the highest resistance among the three resistors, while the resistor 804 may have the lowest resistance among the three resistors. Originally, before increasing sensitivity, the resistance of the path through which Vcc is connected to the base terminal may be kept minimal by turning on the switch 810, which is connected to the resistor 804, and by turning off the switches 806 and 808. Subsequently, to increase sensitivity, the switch 810 may be turned off and the switch 808 may be turned on, thereby increasing resistance of the path. To cause a further increase in the sensitivity, the switch 808 may be turned off and the switch 806 may be turned on.

FIG. 9 illustrates the control circuit 208 for facilitating increase of sensitivity of the optical transducer 206, according to an example implementation of the present subject matter. Here, the decrease in the base voltage is achieved by increasing the base current of the output transistor 402, i.e., the current flowing at the base terminal. The increase in the base current may be achieved using a resistor 902 connected to the base terminal. The resistor 902 may be connected to an anode terminal of a diode 904. A cathode terminal of the diode 904 may be connected to an output terminal 906, such as a GPIO terminal, of the control circuit 208.

Originally, before increasing the sensitivity, the control circuit 208 may provide a logic 1 signal at the output terminal 906, causing the diode 904 to be reverse-biased and preventing flow of current through the resistor 902. To increase the sensitivity, the control circuit 208 may provide a logic 0 signal at the output terminal 906, causing the diode 904 to be forward-biased. Therefore, a current flows from Vcc to ground through the base terminal of the output transistor 402, the resistor 902, and the diode 904. Such a current adds to the current that flows from Vcc to ground through the base terminal of the output transistor 402 and the phototransistor 404. Therefore, the current at the base terminal of the output transistor 402 increases and the base voltage decreases.

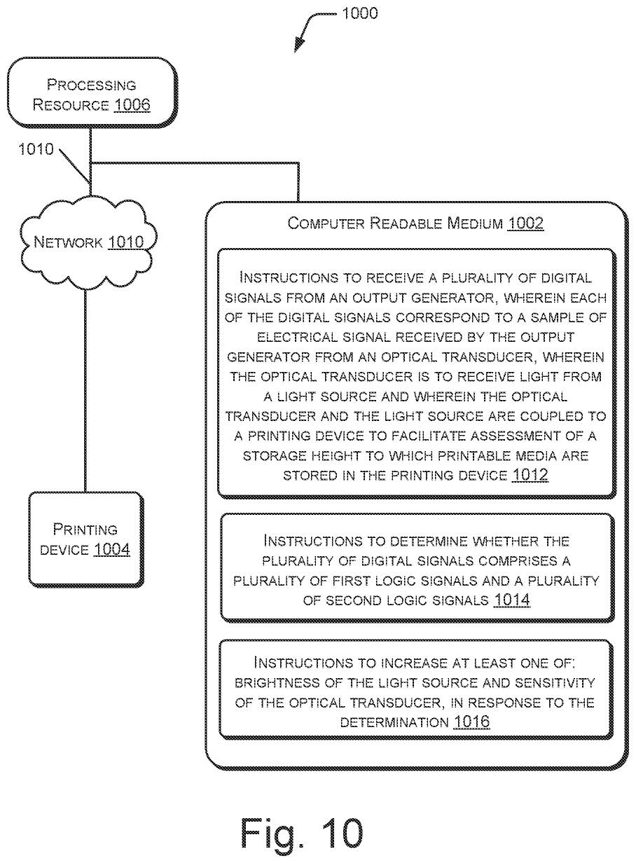

FIG. 10 illustrates a computing environment 1000, implementing a non-transitory computer-readable medium 1002 for controlling assessment of storage height of printable media in a device, according to an example implementation of the present subject matter.

In an example, the non-transitory computer-readable medium 1002 may be utilized by a printing device 1004, which may correspond to the device 100. Accordingly, the storage height may also be referred to as stacking height, as printable media are stacked in the printing device 1004. The printing device 1004 may be implemented in a public networking environment or a private networking environment. In an example, the computing environment 1000 may include a processing resource 1006 communicatively coupled to the non-transitory computer-readable medium 1002 through a communication link 1008.

In an example, the processing resource 1006 may be implemented in a device, such as the printing device 1004. The non-transitory computer-readable medium 1002 may be, for example, an internal memory device of the printing device 1004. In an implementation, the communication link 1008 may be a direct communication link, such as any memory read/write interface. In another implementation, the communication link 1008 may be an indirect communication link, such as a network interface. In such a case, the processing resource 1006 may access the non-transitory computer-readable medium 1002 through a network 1010. The network 1010 may be a single network or a combination of multiple networks and may use a variety of different communication protocols. The processing resource 1006 and the non-transitory computer-readable medium 1002 may also be communicatively coupled to the printing device 1004 over the network 1010.

In an example implementation, the non-transitory computer-readable medium 1002 includes a set of computer-readable instructions to facilitate assessment of stacking height, i.e., the height to which printable media are stacked in the printing device 1004. The set of computer-readable instructions can be accessed by the processing resource 1006 through the communication link 1008 and subsequently executed to perform acts to control assessment of stacking height in the printing device 1004.

Referring to FIG. 10, in an example, the non-transitory computer-readable medium 1002 includes instructions 1012 that cause the processing resource 1006 to receive a plurality of digital signals from an output generator, such as the output generator 416. Each digital signal corresponds to a sample of an electrical signal received by the output generator from an optical transducer, such as the optical transducer 206, which receives light from a light source, such as the light source 204. The optical transducer and the light source may be coupled to the printing device 1004 to facilitate assessment of the stacking height. For instance, optical transducer and the light source may facilitate determining whether printable media are stacked above a threshold height in the printing device 1004.

The non-transitory computer-readable medium 1002 includes instructions 1014 that cause the processing resource 1006 to determine the plurality of digital signals includes both first logic signals and second logic signals. The presence of both the first logic signals and the second logic signals may indicate that particulate matter is deposited on the light source, the optical transducer, or both, as explained earlier.

The non-transitory computer-readable medium 1002 includes instructions 1016 that cause the processing resource 1006 to increase brightness of the light source, increase sensitivity of the optical transducer, or both, in response to the determination. Such an increase may compensate for decrease in the intensity of light received by the optical transducer due to particulate matter deposition, as explained earlier.

In an example, upon increasing the brightness, instructions of the non-transitory computer-readable medium 1002 facilitate receiving a second plurality of digital signals. If the second plurality of digital signals includes both first logic signals and second logic signals, the instructions allow the processing resource 1006 to infer that the particulate matter deposition is not yet compensated for. Subsequently, it may be determined whether current supplied to the light source can be increased. Such a determination may be based on current rating of the light source, current supply capacity of the printing device 1004, or both. As explained with reference to FIG. 6, the current supply capacity of the printing device 200 depends on the number of resistors connected to the light source and the resistance values of the resistors. If it is determined that the current supplied to the light source can be increased, the current supplied to the light source may be increased. If it is determined that the current supplied cannot be increased, the light source may be disabled.

In an example, upon increasing the brightness, instructions of the non-transitory computer-readable medium 1002 facilitate receiving a third plurality of digital signals. If the third plurality of digital signals includes second logic signals alone, and no first logic signals, it may be inferred that either the stacking height is above the threshold height or particulate matter deposition is such that no or minimal light is received by the optical transducer, as explained with reference to FIG. 6. Accordingly, the instructions may facilitate prompting a user of the printing device 1004 to indicate whether printable media are stacked above the threshold height. If the user indicates that the printable media are not stored above the threshold height, it may be inferred that the continuous stream of second logic signals is due to particulate matter deposition. Accordingly, the instructions may facilitate disabling of the light source.

The present subject matter facilitates reliable detection as to when storage height in a device exceeds a threshold height. For instance, generation of false alarms due to particulate matter deposition on components utilized for height determination is prevented. Also, the present subject matter utilizes components that are already utilized in printing and shredding devices. Further, the present subject matter may not utilize additional components, such as analog-to-digital converter (ADC). Accordingly, the present subject matter can be achieved in a simple and a cost-effective manner.

The present subject matter also facilitates compensating for a decrease in light intensity of the light source due to its ageing. For instance, a decrease in intensity of light emitted by the light source due to its ageing can be compensated for by increasing its brightness. Thus, the present subject matter facilitates reliable assessment of storage height for a longer period of time.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter.

What is claimed is:

1. A device comprising:
a container to store a material;
a storage height assessor to facilitate determination that a storage height, to which the material stored in the container, is above a threshold height, the storage height assessor comprising:
a light source; and
an optical transducer to receive light from the light source and generate a signal corresponding to an intensity of light received; and
a controller to:
determine, based on the signal, that light having intensity not satisfying a threshold intensity is received for a storage height below the threshold height; and
control brightness of the light source in response to the determination that light having intensity not satisfying the threshold intensity is received for a storage height below the threshold height.

2. The device of claim 1, wherein the controller comprises:
an output generator to generate a plurality of digital signals corresponding to a plurality of samples of the signal; and
an output analyzer to identify a variability in the plurality of digital signals, wherein the determination that light not having intensity satisfying the threshold is based at least in part on the variability.

3. The device of claim 2, wherein the controller is to:
generate a first digital signal in response to receiving a sample having a value within a first range of values;
generate a second digital signal in response to receiving a sample having a value within a second range of values, the second range of values being non-overlapping with the first range of values; and
generate either first digital signal or the second digital signal in response to receiving a sample having a value between the first range of values and the second range of values.

4. The device of claim 3, wherein, upon increasing the brightness, the output generator is to:
generate a second plurality of digital signals corresponding to a second plurality of samples of the signal, and
the output analyzer is to:
identify the absence of the second digital signals in the second plurality of digital signals; and
after the identification of the absence of the second digital signals, if a second digital signal is received, trigger an alarm, to indicate that the storage height is above the threshold height.

5. The device of claim 2, wherein, upon increasing the brightness, the output generator is to:
generate a second plurality of digital signals corresponding to a second plurality of samples of the signal, and
in response to the presence of second digital signals in the second plurality of digital signals, the output analyzer is to increase the brightness of the light source further.

6. The device of claim 1, wherein the controller is to:
measure a value of the signal; and
determine that light having intensity not satisfying the threshold intensity is received for a storage height below the threshold height in response to the value of the signal being between a first range of values and a second range of values, wherein the first range of values corresponds to a storage height below the threshold height and wherein the second range of values corresponds to a storage height above the threshold height.

7. A device comprising:
a light source;
an optical transducer to:
receive light emitted by the light source; and
generate an electrical signal corresponding to the received light, wherein a value of the electrical signal is to be in a first range of values in response to a storage height of a media tray being less than a threshold height, wherein the value of the electrical signal is to be in a second range of values in response to the storage height being greater than the threshold height; and
a control circuit to control assessment of the storage height, wherein the control circuit is to:
receive the electrical signal;
determine that the value of the electrical signal is outside of the first range of values and the second range of values; and
increase at least one of: brightness of the light source and sensitivity of the optical transducer, in response to the determination.

8. The device of claim 7, wherein the control circuit comprises an output generator to:
receive a sample of the electrical signal;
generate a first logic signal in response to the sample having a value in the first range of values;
generate a second logic signal in response to the sample having a value in the second range of values; and
generate either the first logic signal or the second logic signal in response to the sample having a value outside of the first range of values and the second range of values; and
an output analyzer to:
receive a plurality of digital signals corresponding to a plurality of samples of the electrical signal; and
determine that the value of electrical signal is outside of the first range of values and the second range of values in response to the plurality of digital signals having both the first logic signals and the second logic signals.

9. The device of claim 7, wherein the optical transducer comprises:
a phototransistor to:
receive the light emitted by the light source; and
generate a photocurrent based on intensity of the light received; and
an output transistor to:
receive a voltage corresponding to the photocurrent at a base terminal of the output transistor; and
output the electrical signal.

10. The device of claim 7, wherein the optical transducer comprises a phototransistor to:
receive the light emitted by the light source; and
output the electrical signal.

11. The device of claim 7, comprising a plurality of resistors connected to a terminal of the light source and through which the light source is connectable to ground, wherein, to increase the brightness of the light source, the control circuit is to:
increase a number of resistors through which the terminal of the light source is connected to ground.

12. The device of claim 7, wherein the optical transducer comprises an output transistor that is to output the electrical signal based on a value of voltage at a base terminal of the output transistor, wherein, to increase the sensitivity of the optical transducer, the control circuit is to control the value of the voltage at the base terminal.

13. A non-transitory computer-readable medium comprising instructions for controlling assessment of a storage height, the instructions being executable by a processing resource to:
receive a plurality of digital signals from an output generator, wherein each of the digital signals correspond to a sample of electrical signal received by the output generator from an optical transducer, wherein the optical transducer is to receive light from a light source and wherein the optical transducer and the light source are coupled to a printing device to facilitate assessment of a storage height to which printable media are stored in the printing device;
determine whether the plurality of digital signals comprise a plurality of first logic signals and a plurality of second logic signals; and
increase at least one of: brightness of the light source and sensitivity of the optical transducer, in response to the determination.

14. The non-transitory computer-readable medium of claim 13, wherein, upon increasing the brightness, the instructions are executable by the processing resource to:
receive a second plurality of digital signals; and
in response to the second plurality of digital signals comprising a plurality of first logic signals and a plurality of second logic signals:
determine whether current supplied to the light source is increasable based on at least one of: current rating of the light source and current supply capacity of the printing device;
in response to determining that the current supplied to the light source is increasable, increase the current supplied to the light source; and
in response to determining that the current supplied to the light source is not increasable, disable the light source.

15. The non-transitory computer-readable medium of claim 13, wherein the instructions are executable by the processing resource to:
receive a third plurality of digital signals; and
in response to the third plurality of digital signals comprising a plurality of first logic signals and no second logic signals:
prompt a user of the printing device to indicate whether printable media are stored above a threshold height; and
in response to an indication that the printable media are not stored above the threshold height, disable the light source.
